(19) United States
(12) Patent Application Publication
(10) Pub. No.: US 2008/0169647 A1
(43) Pub. Date: Jul. 17, 2008

(54) Hermetic refrigerant fitting

(76) Inventors: William James Kumpf, Lockport, NY (US); James Allen Baker, Williamsville, NY (US); Prasad Shripad Kadle, Williamsville, NY (US)

Correspondence Address: DELPHI TECHNOLOGIES, INC., M/C 480-410-202, PO BOX 5052, TROY, MI, 48007, US

(21) Appl. No.: 11/653,704

(22) Filed: Jan. 16, 2007

(51) Int. Cl. F16L 27/04

(52) U.S. Cl. 285/261

(57) ABSTRACT

A pipe coupling assembly includes two identical pipes each extending into an enlarged collar and then into a hemispherical socket each with a socket radius. A bulbous insert engages the sockets of the pipes. A clamping mechanism is disposed about the pipes and includes two blocks for holding the sockets into engagement with the insert. The insert has two necks both extending axially around the flow passage and fitting into the pipes. The insert defines a slot extending radially and circumferentially about the axis for allowing movement of two hemispheres relative to one another. Each of the hemispheres has an insert radius. The socket radii are greater than the respective insert radii for establishing a contact line between the insert and the sockets which becomes a contact band as the blocks move together.

### BACKGROUND OF THE INVENTION

1. Field of the Invention

A pipe coupling assembly connects a first pipe to a second pipe.

2. Description of the Prior Art

Current methods for joining components of fluid handling systems, such as air conditioning systems, typically use fittings with elastomeric seals, such as o-rings or seal washers, to contain the fluid. Elastomeric seals work well in applications of moderate temperature and pressure condition and where some small amount of leakage or permeation of the refrigerant or working fluid is tolerable. The fittings themselves are often machined and brazed or welded to the pipes, adding another potential leak location. Some fittings form the pipe itself to create the surface on which the seal is located.

In applications where temperatures or pressures become extreme however, elastomeric seal properties degrade or exhibit excessive fluid/refrigerant emission. One such application, for example, is an air conditioning (A/C) system utilizing CO2 as the refrigerant. The CO2 A/C system typically has refrigerant temperatures exceeding 300 degrees F. and pressures exceeding 2000 PSIG. These conditions exceed the capabilities of elastomeric seals.

Currently, applications involving high temperature or pressure sometimes use a flared pipe style fitting or ferrule type fitting to provide a metal-to-metal seal. Both of these designs typically involve the plastic deformation of the pipe seal surface resulting in a one-time-use connection.

Examples of pipe fittings include U.S. Pat. No. 5,332,267 to Harrison, U.S. Pat. No. 5,362,229 to Yamaga, U.S. Pat. No. 4,928,998 to Brandener, and U.S. Pat. No. 4,343,499 to Dumar, Jr. et al.

Brandener, Harrison and Dumar all disclose a coupling assembly for connecting two pipes in which the second pipe forms the coupling having a spherical outer surface. This adds costs due to the requirement of manufacturing two different pipe ends.

The Harrison patent teaches a pipe coupling assembly for connecting a first pipe having a socket to a second pipe. The end of the second pipe is spherical and has a flow passage with a diameter slightly less than the diameter of the pipe to accommodate misaligning. The second pipe forms the coupling and is inserted into the first pipe and a clamping mechanism is disposed over the pipes. A ferrule is disposed between the first pipe and the clamping mechanism forming two contact areas in order to deform the socket of the first pipe to contact the surface of the second pipe. Initial contact of the flared surface of the first pipe and the spherical surface of the second pipe is along a line of contact, as distinguished from surface contact. However, the clamping mechanism compresses on the first pipe forcing the flared surface of the first pipe to conform about the line of contact and into the spherical surface of the second pipe to increase the contact from the line to a sealing land of definitive width, i.e., a band of contact.

The Yamaga patent discloses a pipe coupling assembly including a first pipe having a socket and a second pipe having a spherical-shaped end and a flow passage. The second pipe forms the coupling and is inserted into the socket of the first pipe and secured using a clamping mechanism. An o-ring in conjunction with a groove on the socket of the first pipe forms a seal between the first pipe and the second pipe.

Although the prior art provides a coupling assembly having sealing capabilities, there remains a need for a coupling assembly able to align itself with a pipe. More specifically, there is a need for an assembly is able to be aligned with two identical pipes, thus requiring a minimum number of components, while simultaneously providing unrestricted flow through the assembly.

### SUMMARY OF THE INVENTION AND ADVANTAGES

The invention provides for a first pipe and a second pipe each having an end extending radially outwardly into a hemispherical socket. An insert having a bulbous shape engages the sockets of the pipes and defines a flow passage extending along an axis between the pipes. A clamping mechanism is disposed about the pipes for holding the sockets into engagement with the insert. The insert has a first neck extending axially around the flow passage and fitting into the first pipe and a second neck extending axially around the flow passage and fitting into the second pipe for substantially aligning the pipes with the axis.

The present invention overcomes the shortcomings of relying on elastomeric seals and also allows re-use by creating a unique metal-to-metal seal geometry staying within the metal's elastic limits. Furthermore, the invention does not require threaded parts or o-rings. Also, because the ends of each pipe can be identical, it reduces manufacturing costs by allowing for the use of identical pipe ends as well as a minimum number of components. Moreover, the invention self aligns the insert with the two pipes while allowing for small movement between the two pipes within the elastic limit of the insert material. Additionally, the assembly provides unrestricted flow therethrough by providing a substantially uniform diameter, and thus cross-sectional area, between the pipes and the insert.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a cross-sectional view of one embodiment of the invention illustrating the insert aligned in both pipes and one bolt in the clamping mechanism;

FIG. 2 is an enlarged view of FIG. 1 illustrating greater socket radii than insert radii exaggerated for illustrative purposes;

FIG. 3 is a perspective view in cross-section of a second embodiment of the invention illustrating a slot in the insert; and

FIG. 4 is a top view of the embodiment shown in FIG. 2 illustrating the clamping mechanism.

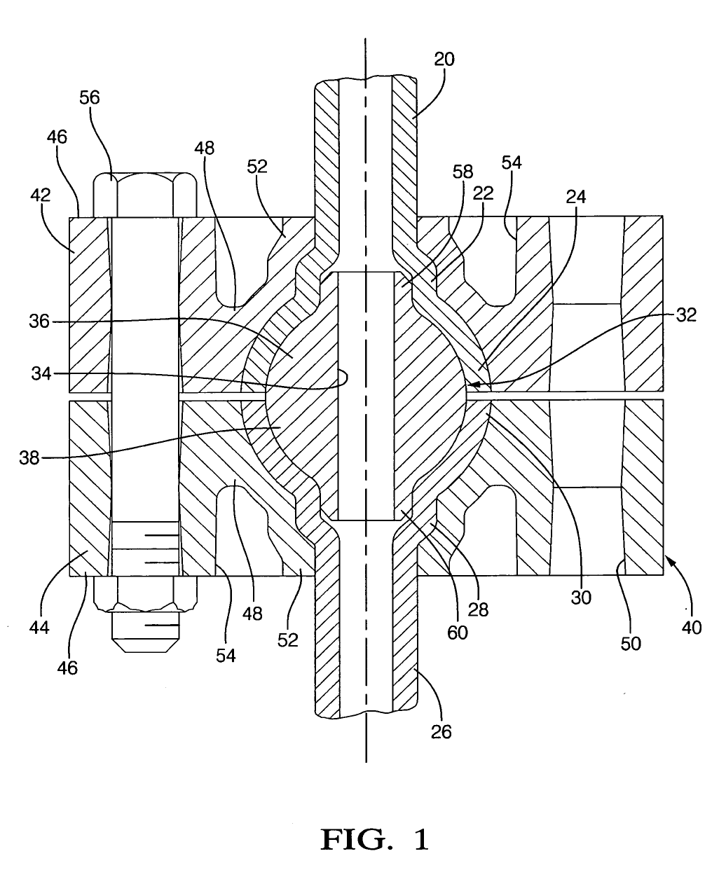

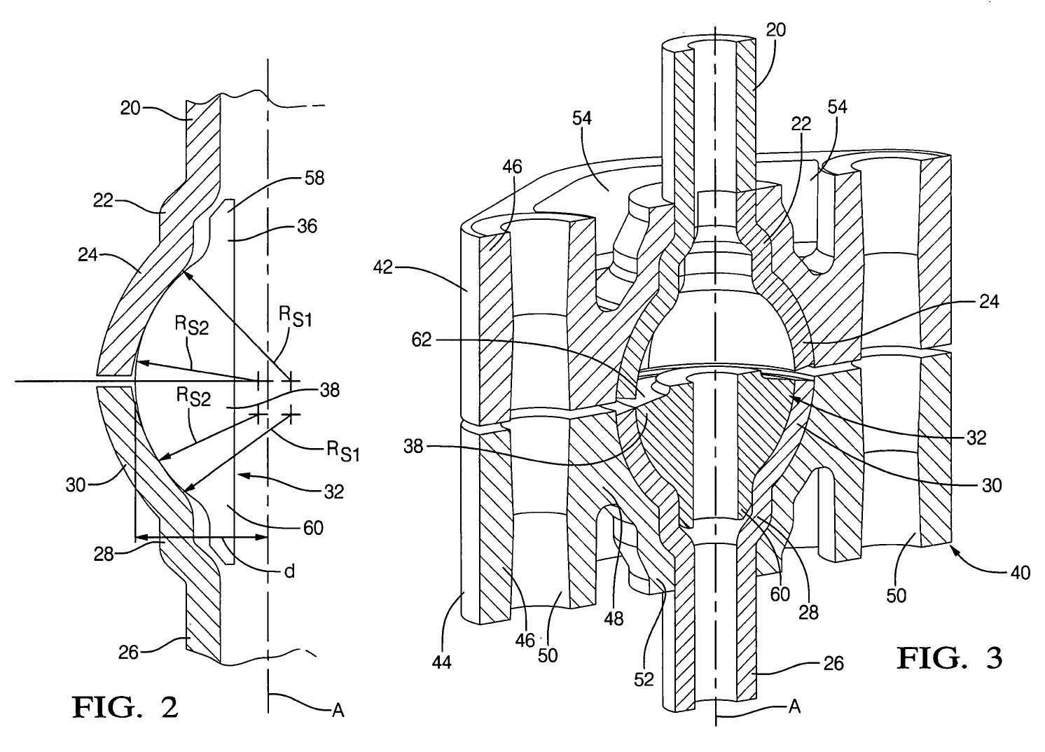

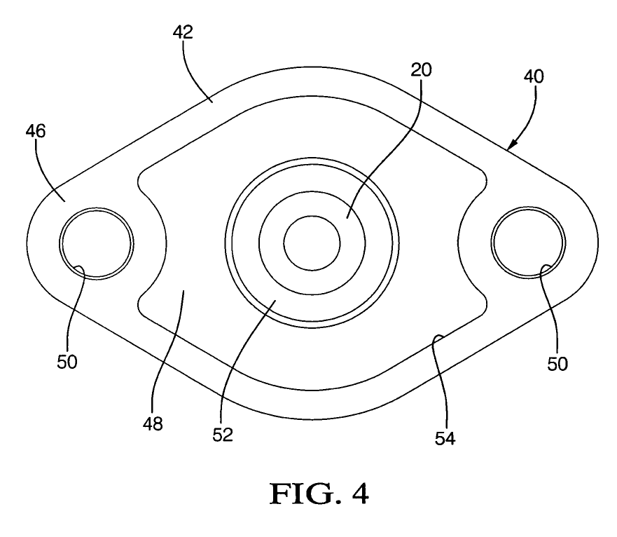

### DETAILED DESCRIPTION OF THE INVENTION

Referring to the Figures, wherein like numerals indicate corresponding parts throughout the several views, a pipe coupling assembly is generally shown.

A first pipe 20 has an end which extends radially outwardly into an enlarged first collar 22 and then into a first hemispherical socket 24 having a first socket radius R_{S1}. A second pipe 26 has an end which extends radially outwardly into an enlarged second collar 28 and then into a second hemispherical socket 30 having a second socket radius R_{S2}. In one embodiment, the first and second pipes 20, 26 are identical in shape and size to one another and the first and second sockets 24, 30 are identical in shape and size, i.e., the first socket radius R_{S1} is equal to the second socket radius R_{S2}. Similarly, the first and second collars 22, 28 are identical in shape and size to one another, thus requiring one tool to form the sockets 24, 30 on each pipe, lowering the cost of manufacturing the assembly.

The assembly includes an insert 32, generally indicated, having a bulbous, or nearly spherical shape, e.g., an apple shape, for engaging the sockets 24, 30 of the pipes 20, 26. The insert 32 is bulbous to accommodate some misalignment of the insert 32 relative to the pipes 20, 26 without changing the contact area or, more importantly, the sealing function.

The insert 32 defines a flow passage 34 extending along an axis A A between the pipes 20, 26. The insert 32 has a center diameter d d about the axis A A with a first hemisphere 36 having a first insert radius R_{I1} on one side of the diameter d d and a second hemisphere 38 having a second insert radius R_{I2} on the other side of the diameter d d. In one embodiment, the first insert radius R_{I1} is equal to the second insert radius R_{I2}.

The first socket radius R_{S1} is greater than the first insert radius R_{I1} and the second socket radius R_{S2} is greater than the second insert radius R_{I2} such that insertion of each of the hemispheres 36, 38 of the insert 32 into each of the respective sockets 24, 30 forms a circular contact line between each of the sockets 24, 30 and the insert 32, e.g., a latitude line. The difference between each socket radius R_{S1}, R_{S2} and the corresponding insert 32 radius R_{I1}, R_{I2} directly depends on the elastic limit of the materials used. If the materials of the insert 32 and the pipes 20, 26 have higher elastic limits the difference between the radii may be greater. Similarly, if the materials have lower elastic limits, the difference between the radii must be smaller to avoid plastic deformation.

A clamping mechanism 40, generally indicated, is disposed about the pipes 20, 26 for holding the sockets 24, 30 into engagement with the insert 32. The clamping mechanism 40 includes a first block 42 disposed about the first pipe 20 and a second block 44 disposed about the second pipe 26. Each of the blocks 42, 44 includes a clamping ring 46 extending circumferentially about the clamping portion 48 and defining a plurality of holes 50 extending axially.

Each of the blocks 42, 44 of the clamping mechanism 40 includes a throat portion 52 having a diameter d smaller than the collars 22, 28 and axially engaging one of the collars 22, 28 and a spherical clamping portion 48 extending from the throat portion 52 and about one of the sockets 24, 30. The throat portion 52 and the spherical clamping portion 48 of each block profile each of the pipes 20, 26 leaving a small space between the throat portion 52 of the blocks 42, 44 and the collars 22, 28 of the pipes 20, 26 in order to evenly transfer the load from the clamping mechanism 40 to the perimeter of the sockets 24, 30 of the pipes 20, 26. Each of the blocks 42, 44 defines an annular recess 54 extending axially thereinto between the clamping portion 48 and the clamping ring 46 for allowing a small amount of movement of the clamping ring 46 relative to the throat portion 52.

The clamping mechanism 40 includes a plurality of bolts 56 disposed in the holes 50 in the clamping ring 46 of the blocks 42, 44 for clamping the first block 42 to the second block 44. The bolts 56 move the sockets 24, 30 into engagement with the insert 32 along the line contact between each of the hemispheres 36, 38 and each of the sockets 24, 30 as the blocks 42, 44 are moved together. In theory, the geometry of the contact area remains a line while the blocks 42, 44 move together, however, in practice, the surface of the insert 32 is matched closely to that of the pipe so that it produces a contact band, with the highest load at the center, due to elastic deformation of the pipe and the insert 32 adjacent to this line of contact.

A layer of polymeric material may be disposed on the hemispheres 36, 38 of the insert 32 for forming a seal between the insert 32 and the sockets 24, 30 by filling surface imperfections in the insert 32 and the sockets 24, 30. The polymeric material may be coated on the surface of the insert 32 or the insert 32 may be impregnated with the polymeric material.

The assembly is distinguished by the insert 32 having a first neck 58 extending axially around the flow passage 34 and terminating in a chamfered end and a second neck 60 extending axially around the flow passage 34 and terminating in a chamfered end. The first neck 58 fits with loose clearance into the first collar 22 of the first pipe 20 and the second neck 60 fits with loose clearance into the second collar 28 of the second pipe 26 to substantially align the pipes 20, 26 with the axis A. A small space is provided between the chamfered ends of the necks 58, 60 and each of the collars 22, 28.

Although the first and second necks 58, 60 may be inserted into the first and second pipes 20, 26 respectively, the necks 58, 60 are preferably inserted into the first and second collars 22, 28 so that the inside diameters d of the pipes 20, 26 are substantially equal to the diameter d of the flow passage 34, thus creating unrestricted flow through the assembly.

As shown in FIG. 3, the insert 32 defines a slot 62 extending radially and circumferentially about the axis A on the diameter d of the insert 32 for allowing movement of the first hemisphere 36 relative to the second hemisphere 38. The slot 62 is U-shaped and provides increased compliance allowing more deflection between the two hemispheres 36, 38 within elastic limits and increases the assembly's tolerance of thermal expansion and vibration inputs. The slot 62 may also allow small movement between the first pipe 20 and the second pipe 26 without causing sliding between the insert 32 and the sockets 24, 30, reducing wear or galling and subsequent leakage.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A pipe coupling assembly comprising;
a first pipe having an end extending radially outwardly into a first hemispherical socket having a first socket radius,
a second pipe having an end extending radially outwardly into a second hemispherical socket having a second socket radius,
an insert having a bulbous shape for engaging said sockets of said pipes and defining a flow passage extending along an axis between said pipes and having a center diameter about said axis with a first hemisphere having a first insert radius on one side of said diameter and a second hemisphere having a second insert radius on the other side of said diameter,
a clamping mechanism disposed about said pipes for holding said sockets into engagement with said insert, and
said insert having a first neck extending axially around said flow passage and fitting into said first pipe and a second neck extending axially around said flow passage and fitting into said second pipe for substantially aligning said pipes with said axis.

2. An assembly as set forth in claim 1 wherein said first socket radius is greater than said first insert radius and said second socket radius is greater than said second insert radius whereby insertion of said insert into said sockets forms a circular contact line between said each of said hemispheres of said insert and each of said sockets.

3. An assembly as set forth in claim 1 wherein said first socket radius is equal to said second socket radius and said first insert radius is equal to said second insert radius,
whereby said first hemispherical socket is equal in size and shape to said second hemispherical socket and said first hemisphere of said insert is equal in size and shape to said second hemisphere of said insert.

4. An assembly as set forth in claim 1 wherein said first pipe extends into an enlarged first collar and then into said first socket and said second pipe extends into an enlarged second collar and then into said second socket, and wherein said first neck fits into said first collar and said second neck fits into said second collar.

5. An assembly as set forth in claim 4 wherein said first collar is identical in shape and size to said second collar and wherein said first hemispherical socket is equal in size and shape to said second hemispherical socket and said first hemisphere of said insert is equal in size and shape to said second hemisphere of said insert.

6. An assembly as set forth in claim 4 wherein said first neck and said second neck each terminate in a chamfered end.

7. An assembly as set forth in claim 4 wherein said clamping mechanism includes a first block disposed about said first pipe and a second block disposed about said second pipe.

8. An assembly as set forth in claim 7 wherein each of said blocks includes a throat portion having a diameter smaller than said collars and axially engaging one of said collars and a spherical clamping portion extending from said throat and about one of said sockets.

9. An assembly as set forth in claim 8 wherein each of said blocks includes a clamping ring extending circumferentially about said clamping portion and defining a plurality of holes extending axially.

10. An assembly as set forth in claim 9 wherein each of said blocks defines an annular recess extending axially thereinto between said clamping portion and said clamping ring.

11. An assembly as set forth in claim 10 wherein said first socket radius is greater than said first insert radius and said second socket radius is greater than said second insert radius whereby insertion of said insert into said sockets forms a circular contact line between said each of said hemispheres of said insert and each of said sockets.

12. An assembly as set forth in claim 11 wherein said clamping mechanism includes a plurality of bolts disposed in said holes in said clamping ring of said blocks for clamping said first block to said second block to move said sockets into engagement with said insert along line contact between each of said hemispheres and each of said sockets as said blocks are moved together.

13. An assembly as set forth in claim 1 wherein said insert defines a slot extending radially and circumferentially about said axis for allowing movement of said first hemisphere relative to said second hemisphere.

14. An assembly as set forth in claim 13 wherein said slot of said insert extends on said diameter of said insert.

15. An assembly as set forth in claim 1 including a layer of polymeric material disposed on said hemispheres of said insert for forming a seal between said insert and said sockets by filling surface imperfections in said insert and said sockets.

16. A pipe coupling assembly comprising;
a first pipe having an end extending radially outwardly into a first hemispherical socket,
a second pipe having an end extending radially outwardly into a second hemispherical socket identical in shape and size to respective ones of said first pipe and said first socket,
an insert having a bulbous shape for engaging said sockets of said pipes and defining a flow passage extending along an axis between said pipes and having a center diameter about said axis with a first hemisphere on one side of said diameter and a second hemisphere on the other side of said diameter,
a clamping mechanism disposed about said pipes for holding said sockets into engagement with said insert, and
said insert defining a slot extending radially and circumferentially about said axis for allowing movement of said first hemisphere relative to said second hemisphere.

17. A pipe coupling assembly comprising;
a first pipe having an end extending into an enlarged first collar and then into a first hemispherical socket having a first socket radius,
a second pipe having an end extending into an enlarged second collar and then into a second hemispherical socket having a second socket radius,
said second pipe, second collar, and second socket being identical in shape and size to respective ones of said first pipe and said first collar and said first socket,
an insert having a bulbous shape for engaging said sockets of said pipes and defining a flow passage extending along an axis and having a center diameter about said axis with a first hemisphere having a first insert radius on one side of said diameter and a second hemisphere having a second insert radius on the other side of said diameter,
said first socket radius being greater than said first insert radius and said second socket radius being greater than said second insert radius,
a clamping mechanism including a first block disposed about said first pipe and a second block disposed about said second pipe for holding said sockets into engagement with said insert,
each of said blocks including a clamping ring extending circumferentially about said clamping portion and defining a plurality of holes extending axially,
said clamping device including a plurality of bolts disposed in said holes in said clamping ring of said blocks for clamping said first block to said second block to move said sockets into engagement with said insert along line contact between each of said hemispheres and each of said sockets as said blocks are moved together,
a layer of polymeric material disposed on said hemispheres of said insert for forming a seal between said insert and said sockets by filling surface imperfections in said insert and said sockets,
said insert having a first neck extending axially around said flow passage and into said first collar of said first pipe and terminating in a chamfered end and a second neck extending axially around said flow passage and into said second collar of said second pipe and terminating in a chamfered end,
each of said blocks including a throat portion having a diameter smaller than said collars and axially engaging one of said collars and a spherical clamping portion extending from said throat and about one of said sockets, and
each of said blocks defining an annular recess extending axially thereinto between said clamping portion and said clamping ring.

18. An assembly as set forth in claim 17 wherein said insert defines a slot extending radially and circumferentially about said axis on said diameter of said insert for allowing movement of said first hemisphere relative to said second hemisphere.
